(19) United States
(12) Patent Application Publication
(10) Pub. No.: US 2026/0054929 A1
(43) Pub. Date: Feb. 26, 2026

(54) ARTIFICIAL INTELLIGENCE CONTROL AND OPTIMIZATION OF AGENT TASKS IN A WAREHOUSE

(71) Applicants: Dematic GmbH, Heusenstamm (DE); DEMATIC Pty Ltd., Belrose NSW (AU); STILL GmbH, Hamburg (DE)

(72) Inventors: Aleksandar Krnjaic, Bexley NSW (AU); Daniel Huberth, Aschaffenburg (DE); Bengt Abel, Lüneburg (DE); Stefano Albrecht, Edinburgh (GB)

(21) Appl. No.: 19/100,749

(22) PCT Filed: Aug. 4, 2023
(86) PCT No.: PCT/EP2023/071689

§ 371 Date: Feb. 3, 2025

Related U.S. Application Data
(60) Provisional application No. 63/395,059, filed on Aug. 4, 2022.

(51) Int. Cl. B65G 1/137; G05B 13/02

(52) U.S. Cl. CPC B65G 1/1375; G05B 13/027

(57) ABSTRACT

A control system for a warehouse includes a controller for communicating commands for execution by item carrying vehicles, robotic pickers, and human workers. A warehouse simulation performs simulated runs of order picking and replenishment activities. The simulated results and experience data are recorded and stored in storage. The stored data includes operational data including live results and experience data that was recorded while the workers were performing according to the executable commands from the controller. A training module receives the simulation results, the simulated experience data, and the recorded operational data from the storage. The training module trains an algorithm using the simulated data and the operational data. The training module generates an updated algorithm for the controller. Using the updated algorithm, the controller communicates executable commands to the workers.

### CROSS REFERENCE TO RELATED APPLICATION

This is a national stage application of PCT Application No. PCT/EP2023/071689, filed Aug. 4, 2023, which claims benefit of U.S. provisional application, Ser. No. 63/395,059, filed Aug. 4, 2022, which are both hereby incorporated herein by reference in their entireties.

### FIELD OF THE INVENTION

The present invention is directed to the control of order picking systems in a warehouse environment, and in particular to the use of artificial intelligence (AI) algorithms used to control agents (human or robotic) for carrying out the order picking process, including replenishment, storage allocation and batch building.

### BACKGROUND OF THE INVENTION

The control of an order picking and replenishment system with a variety of workers or agents (e.g., human pickers, robotic pickers, item carrying vehicles, conveyors, and other components of the order picking and replenishment system) in a warehouse is a complex task. Conventional algorithms are used to seek various objectives in an ever-increasing order fulfillment complexity characterized by scale of Stock Keeping Unit (SKU) variety, order composition ranging from single SKU to multiple SKUs, widely varying order demand in magnitude and time scales coupled with the very demanding constriction of delivery deadlines. Other changing priorities include the minimization of lead time, order processing schedules, or the scheduling of orders with the highest priorities. A minimization of the energy consumption, minimization of distance travelled, and reduction of labor cost are also important factors. Additional factors, such as, pallet stability, traffic congestion, and avoidance measures are also considered in the control of the warehouse operations. The optimality of these strategies depends on different factors, including warehouse size, warehouse geometry, number of orders, order profiles, slotting allocations, and number of agents (workers) in a system. Heuristic-based algorithms which are written by experts are mostly used in practice to address such challenges. But a good executable heuristic algorithm requires a lot of effort to design, test, implement, optimize, program, and verify, and such algorithms are usually very specific to customer requirements and use cases (that is, not easily transferable to another warehouse and/or customer). Furthermore, these heuristics do not adjust well to changing warehouse operations and/or order conditions.

### SUMMARY OF THE INVENTION

Embodiments of the present invention provide methods and a system for a highly flexible order picking and replenishment solution which can dynamically respond to changing warehouse operations and order conditions. Flexible solutions can be applied to every warehouse with highly variable customer conditions.

Warehouse order fulfillment systems and operations employing exemplary adaptable/trainable algorithmic solutions are well suited to unique customer conditions and can continually adapt and account for changes in operational conditions. The exemplary algorithms also have the capacity to optimize the operations by considering all the different factors discussed in the background of the invention (for instance, energy consumption, labour cost, travel distance, etc.).

Exemplary embodiments of the present invention enable the holistic optimization of the Person-to-Goods (or Person-to-Robot), and Goods-to-Person (or Goods-to-Robot) order picking process by means of strategic decision making and controlling the operations for storing items, retrieving items, building up batches, allocating resources to carry out replenishment of items, assigning orders to pickers and vehicles, selecting resources for a specific task, and allocating and coordinating the vehicle and picker movements to carry out the picking and replenishment processes.

The order picking and replenishment control system for a warehouse includes an exemplary controller for communicating commands for execution by workers or agents (e.g., human pickers, robotic pickers, item carrying vehicles, conveyors, and other components of the order picking and replenishment system). Such a control system may, for example, comprise one or more computers or servers, such as operating in a network, comprising hardware and software, including one or more programs, such as cooperatively interoperating programs.

The exemplary architecture consists of a digital twin warehouse simulation comprising one or more programs operating on one or more computers/servers, such as being executed on one or more processors, which continually performs simulated runs of order picking and replenishment activities within a simulated warehouse. The simulated runs may also use data from a real warehouse order fulfillment operational system. The simulated results data and experience data are recorded in a storage module, such as a database. The storage module includes operational data that includes live results data and experience data that was recorded while agents were performing their tasks according to executable commands communicated by the controller. The operational data may also include data recorded from other warehouses to broaden the knowledge of the learned model. A training module (or training cluster) 210 receives the simulation results, the simulated experience data, and the recorded operational data from the storage module. The training module 210 may comprise one or more programs, such as cooperatively interoperating programs, and is configured to train an algorithm using the simulated data and the operational data. The training module 210 generates new/updated neural network weight results for the algorithm (to update the algorithm) and forwards them to the controller. Using the updated algorithm, the controller 202 communicates executable commands to the workers (for example, human workers, robotic pickers, automated guided vehicles (AGVs), autonomous mobile robots (AMRs), and the like). As discussed herein, AGVs and AMRs can be used interchangeably, with the understanding that they carry out the same role in the order fulfillment system but have different levels of autonomy.

An exemplary method of the present invention includes logging operational data related to the executed order picking and replenishment activities executed in the warehouse. The operational data includes real system results and experience data. The operational data is collected and stored in the storage module. The algorithm is retrained using the updated operational data and the continually generated simulation data. Updated neural network weight results from the retraining of the algorithm are used to generate updated executable commands for the AGVs and robotic pickers.

In this invention the exemplary architecture and method are provided for an AI based self-learning approach to control and optimize the problem holistically.

### An Exemplary First Use Case: Person-to-Goods/Robot-to-Goods:

In this exemplary scenario, the workers (e.g., AGVs, human pickers, robots, etc) are responsible for picking up empty package(s) or order media (in the form of a pallet, tote, empty carton, pouch, etc.) at a designated start point inside the warehouse, and to deliver the completed order(s) at a designated endpoint in the warehouse. An order contains a plurality of items, which are located in different storage locations spread throughout the warehouse. During the picking process, a “picker” worker (human or robot vehicle) moves throughout the warehouse to the various storage locations, which contain the item(s) from the assigned order. The picker then picks the item from the specific storage location (e.g., case, carton, single item, etc.) and onto itself, or onto a separate vehicle (e.g., AGV, robot, cart, pallet jack, pallet truck, etc.). Once all the items within the order(s) are picked, the pickers and/or vehicles move to the designated endpoint to drop off the completed order.

### An Exemplary Second Use Case: Goods-to Person/Goods-to-Robot:

Based on a given order which contains a plurality of items spread across the warehouse, a vehicle (e.g., AGV, cart . . . ) is responsible for bringing the items from their storage locations to a picker (human or robot) that is in a fixed picking location. The vehicle picks up a handling unit (e.g., in the form of a shelf, pallet, tote, etc.) in order to deliver the relevant items contained within the handling unit for an order to the picking location. The picker (e.g., robot/human) then picks the item from the handling unit and places it into a completed order medium (for instance a tote, pallet, pouch, etc.) or into a buffer location (such as a put-wall) for subsequent processing. After the pick is completed, the vehicle can store the handling unit back in the warehouse.

These and other objects, advantages, purposes, and features of the present invention will become apparent upon review of the following specification in conjunction with the drawings.

### BRIEF DESCRIPTION OF THE DRAWINGS

FIG. 1 is a depiction of an exemplary warehouse with various workers performing activities in the warehouse in accordance with the present invention;

FIG. 1A is a diagram of a warehouse layout divided into locations and sections in accordance with the present invention;

FIG. 2 is a diagram of an exemplary systems architecture of an order picking control system showing an exchange of data between sub-systems for a warehouse in accordance with the present invention;

FIG. 3 is a block diagram illustrating the steps to a method for continually training an algorithm and incorporating real experience data for controlling the order picking system of a warehouse in accordance with the present invention;

FIG. 4 is a block diagram illustrating an exemplary reinforcement learning algorithm;

FIG. 4A is a diagram illustrating an exemplary central reinforcement learning controller using neural networks, which is used to train an algorithm for controlling the order picking system of a warehouse in accordance with the present invention;

FIG. 4B is a diagram illustrating an exemplary multi-agent reinforcement learning controller using neural networks, which is used to train an algorithm for controlling the order picking system of a warehouse in accordance with the present invention;

FIG. 4C is a diagram illustrating an exemplary hierarchical multi-agent reinforcement learning controller using neural networks, which is used to train an algorithm for controlling the order picking system of a warehouse in accordance with the present invention;

FIG. 5 is a perspective view of an exemplary digital twin warehouse simulation in accordance with the present invention;

FIGS. 6A, 6B and 6C are diagrams illustrating the exemplary results and improvement of the major KPI's during the learning process of a case study for evaluating an algorithm managing automated guided vehicles (AGVs) and pickers (robotic or human) in an order picking system of a warehouse in accordance with the present invention;

### DESCRIPTION OF THE PREFERRED EMBODIMENTS

The present invention will now be described with reference to the accompanying figures, wherein numbered elements in the following written description correspond to like-numbered elements in the figures.

Artificial intelligence provides for concepts in natural language understanding and computer vision, which has found wide applicability in commercial products, however, large-scale robot control and automation remain challenging and are mostly addressed using conventional fixed strategies.

The exemplary embodiments of the machine learning solutions discussed herein leverage deep reinforcement learning (DRL), multi-agent deep reinforcement learning (MARL) and Hierarchical Reinforcement Learning (HRL) to improve the efficiency and flexibility of order-picker systems in real-world warehouse systems.

The exemplary reinforcement learning solutions have the potential to improve real world performance of such order-picker systems (e.g., by reducing order lead times in any warehouse configuration).

Another benefit of these learning systems in controlling agents (in contrast to conventional fixed strategies) is their flexibility such that they can be effectively applied in any warehouse due to their ability to adapt to novel circumstances. Adaptability allows the exemplary system to continually improve and learn, being able to account for changes in warehouse size, layout, modes of operation, item storage strategy and changes in numbers and types of workers (robotic or human). It also allows the system to incorporate more constraints on its optimization (e.g., pallet stability, energy usage, labor cost) with relative ease, which is especially difficult and cumbersome in a conventional fixed algorithm approach.

Exemplary embodiments of the present invention provide for an AI-based procedure for the control of agents in a warehouse based on deep reinforcement learning to solve a set of described problems. Such embodiments can be implemented with a variety of hardware and software that make up one or more computer systems or servers, such as operating in a network, comprising hardware and software, including one or more programs, such as cooperatively interoperating programs. For example, an exemplary embodiment can include hardware, such as, one or more processors configured to read and execute software programs. Such programs (and any associated data) can be stored and/or retrieved from one or more storage devices. The hardware can also include power supplies, network devices, communications devices, and input/output devices, such devices for communicating with local and remote resources and/or other computer systems. Such embodiments can include one or more computer systems, and are optionally communicatively coupled to one or more additional computer systems that are local or remotely accessed. Certain computer components of the exemplary embodiments can be implemented with local resources and systems, remote or “cloud” based systems, or a combination of local and remote resources and systems. The software executed by the computer systems of the exemplary embodiments can include or access one or more algorithms for guiding or controlling the execution of computer implemented processes, e.g., within exemplary warehouse order fulfilment systems. As discussed herein, such algorithms define the order and coordination of process steps carried out by the exemplary embodiments. As also discussed herein, improvements and/or refinements to the algorithms will improve the operation of the process steps executed by the exemplary embodiments according to the updated algorithms.

An exemplary embodiment includes a learning system where trained neural networks are used as decision makers for the control of these agents in a warehouse. Such an exemplary system would include the following: 1) pre-training based on an environmental/digital twin and the specific resource characteristics and processes to learn general strategies (encoded in neural networks) based on reward functions; 2) synchronization of the real environment with the digital twin; 3) training with and incorporating the real execution data; 4) control of warehouse processes within or via the Warehouse Execution System (WES); and 5) continuous improvement over many cycles of data collection and additional training. The use of trained neural networks as decision makers allows the system to control the operation under all manner of circumstances likely to be encountered.

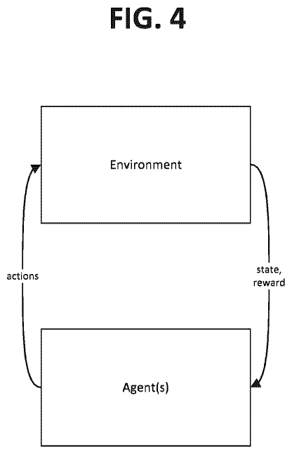

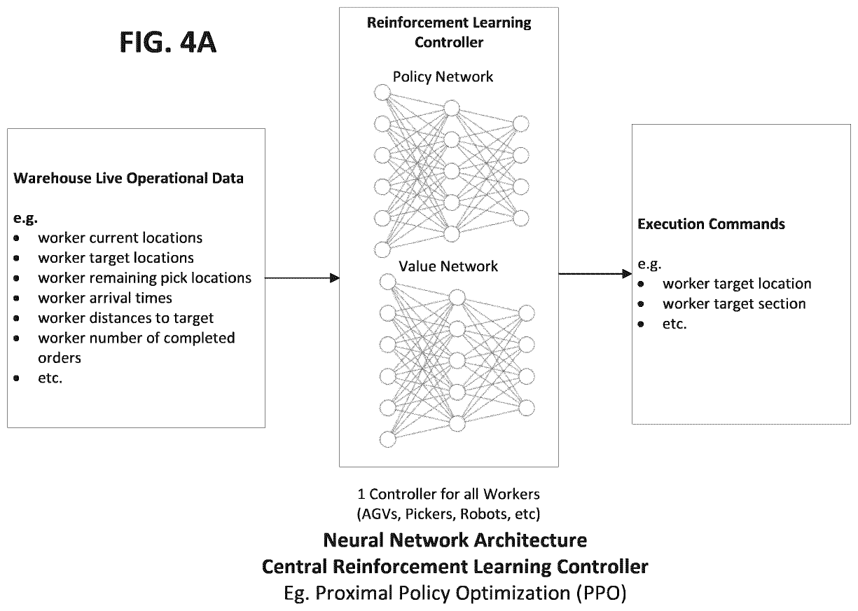

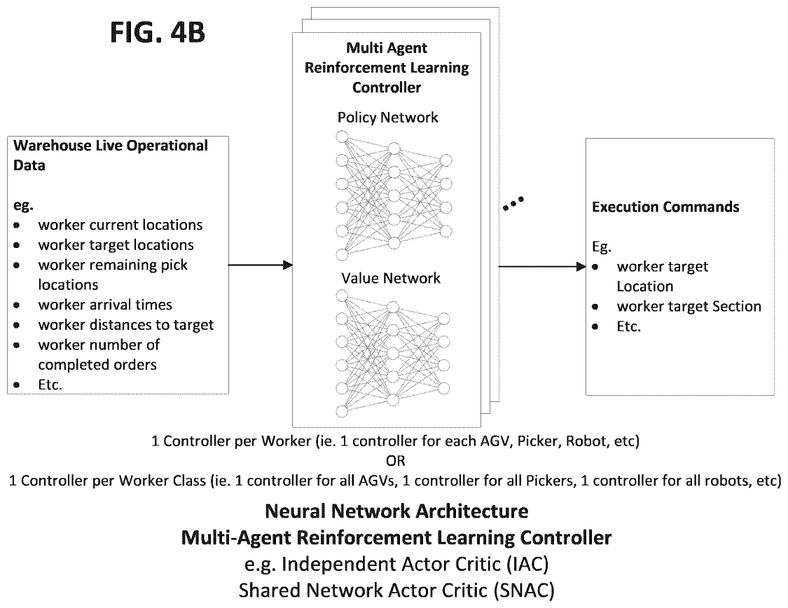

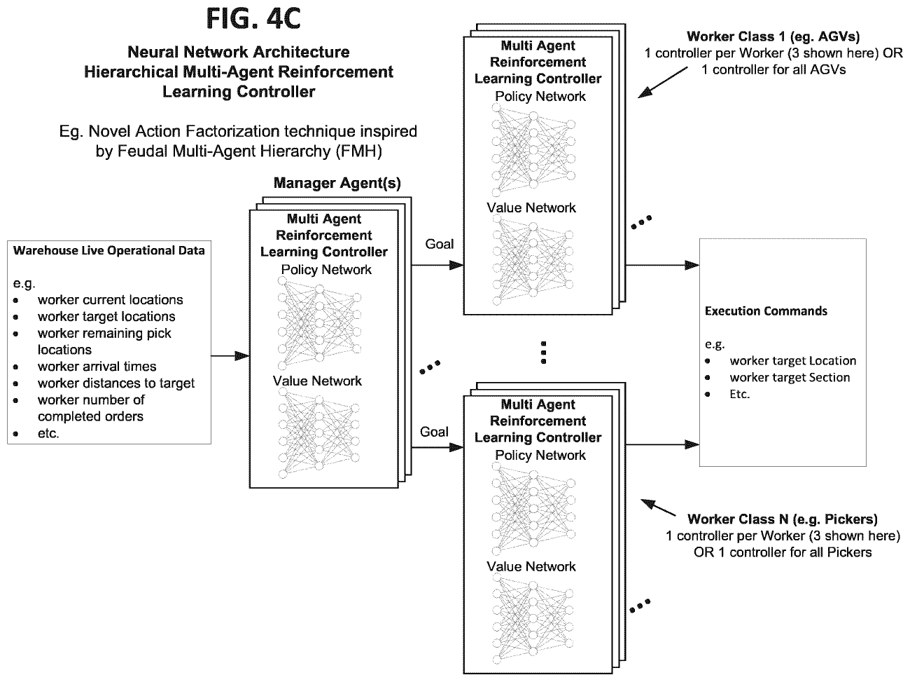

FIG. 4 illustrates the high-level concept of reinforcement learning algorithms. The environment is defined as the model of a simulation or real warehouse environment which has items stored in warehouse locations. “Workers,” which are physical entities, such as, human staff or robots, move through the environment and carry out physical tasks to fulfil orders. The environment state is any information obtainable from the simulated or actual facility's information systems, such as location(s) of workers in the system, target (or future) location(s) of workers in the system, worker busy status, and order data (e.g., remaining picking quantities and item locations).

The agent(s) are defined as the decision-making system, which maps the environment state to a set of actions for each worker and internally tries to predict and maximize the expected cumulative reward. The data communicated by the agents to the environment are actions for each worker in the system, which can include, for example, the target warehouse location or zone the worker should travel to, and what the worker should be doing at its destination.

The “reward” is a numerical value (or another means for indicating value), which communicates the effectiveness of the chosen actions within the environment. The reward function can be derived from many different occurrences in the environment. A positive reward is given for a good action (i.e., a good outcome as a result of actions taken in the environment), and a negative reward is given for a bad action (i.e., a bad outcome as a result of actions taken in the environment). Some examples include completing an order (positive reward), picking up the next item in the order (positive reward), and not moving for a prolonged period of time (negative reward). It should be noted that the reward is not limited to these scenarios and various reward assignments for different environment occurrences can be chosen.

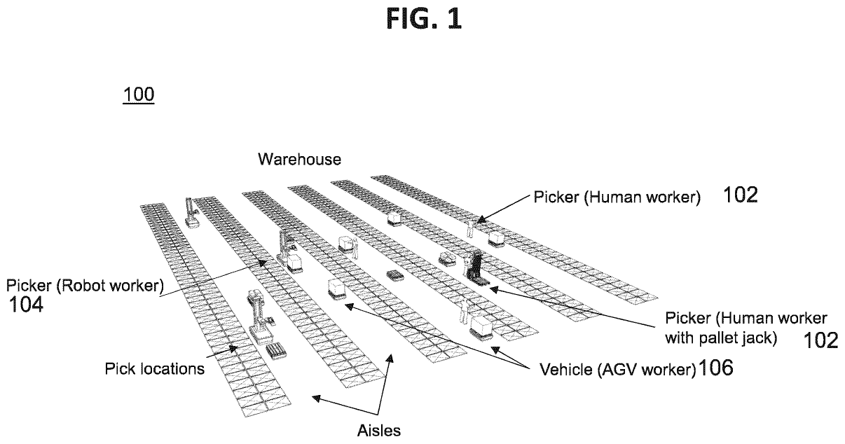

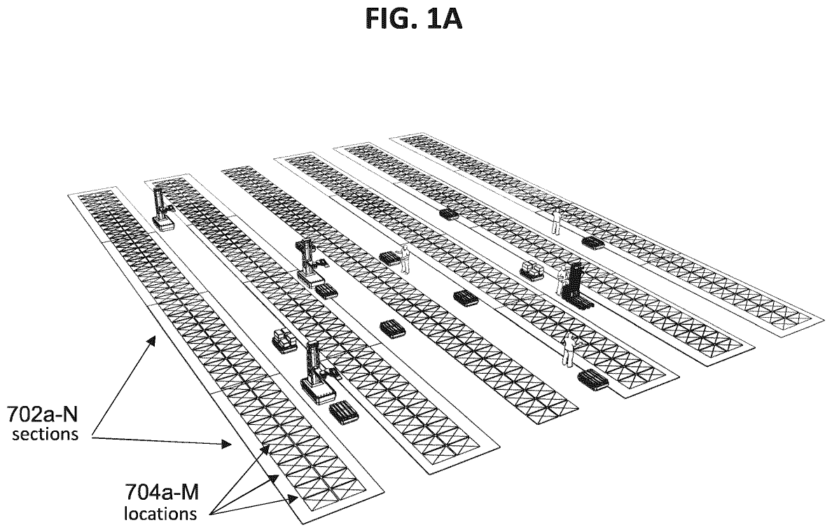

FIG. 1 illustrates an exemplary warehouse environment 100 with a variety of different workers 102, 104, 106. A reinforcement learning agent can control a single worker or a plurality of workers by class (e.g., 1 agent controls all AGVs). Each class of worker has distinct objectives and capabilities. There are three distinct worker classes illustrated in FIG. 1, which include human pickers 102, robotic pickers 104, and automated guided vehicles (AGVs) 106. The overall logistics of the warehouse 100 would be distributed across the classes of workers.

An exemplary controller of the warehouse 100 is configured to provide artificial intelligence (AI) control and optimization of agent tasks in the warehouse 100. An exemplary AI controller, using deep reinforcement learning (DRL a.k.a., RL), is configured to control different types of workers (via RL agents) in the warehouse 100 and to optimize various objectives of the warehouse 100. Those objectives can include, for example, time for order completion/order lead-time, traffic and congestion, reduction in quantity of workers (e.g., pickers, vehicles, and robots), energy usage, travel distance, labor cost, and pallet stability and pick pattern. This can be incorporated very simply in an AI approach (by tuning the reward functions) in contrast to a traditional approach, where an expert programmer tries to incorporate these constraints to the best of their knowledge, using past experience and manual trial and error on a simulator.

Due to the continual learning nature of AI algorithms and the ease of incorporating additional constraints, it is possible to enjoy the following advantages compared to traditional methods where an expert programmer has to specifically tailor their implementation to enjoy these advantages:
1. Continually accounting for changing operating conditions, such as, reconfiguration of warehouse, new staff, new equipment, new vehicles, etc.
2. Continually accounting for changing order conditions, such as, changes in the number of items per order or order profile, seasonal variation, etc.
3. Efficiency increases.
4. Flexibility of the approach to apply to every warehouse.
5. Ease of setup in customer warehouses, simplifying deployment and reducing commissioning time.
6. Scalability to large and complex warehouse systems.
7. Warehouse layout optimization.
8. Slotting optimization.
9. Order prediction.
10. Optimized batch building.

For large systems, the warehouse is divided into “sections” (or “segments”), and the sections further divided into location clusters within those sections, as illustrated in FIG. 1A. A main motivation is to divide the action space to reduce each agent's complexity and to improve exploration efficiency. This is done by introducing a “manager” agent, which provides “goals” to the worker agents, which are target sections that the workers have to travel to. The manager is also an RL agent, albeit a logical (non-physical) one, and the decisions it makes (i.e., the goals it provides to the workers) are also learned via the reinforcement learning approach. The decisions the manager agent makes happen over a longer time horizon than those of the worker agents, requiring an approach that leverages learning over a larger temporal window. This is addressed by using hierarchical reinforcement learning, which is concerned with making decisions over longer time horizons. It is possible to further abstract the spatial division of the warehouse and to introduce other manager agents (i.e., multiple managers, or managers of managers), but for the purpose of this example, a single manager agent is described. By factorizing the action space in this way, it becomes possible to learn efficient policies that will scale with larger warehouse sizes and larger numbers of workers in the system.

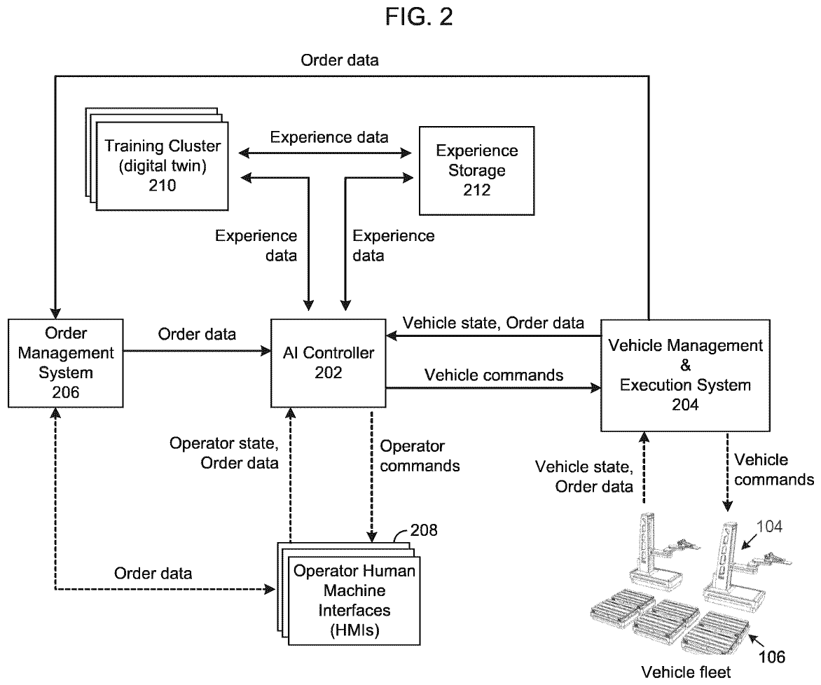

FIG. 2 illustrates an exemplary system architecture, with commands and data communicated between components of the system architecture. With the exception of Operator HMIs, these systems can be physically separated (i.e., run on their own computers, as shown in the figure), or as virtual modules on a single computer, or as virtual modules on the cloud. Example commands and data between systems include:

| Data Name | Data Description |
|---|---|
| Order Data | order IDs, pick quantities, completion quantities, item |
| | locations, order status, item completion times, and item |
| | spatial data, etc. |
| Vehicle | current location, traffic conditions, fleet monitoring |
| State | information, work status, and fault info, etc. |
| Vehicle | target location, target zone, work to perform, order |
| Commands | information etc. |
| Operator | current location, work status, error info, etc. |
| State | |
| (human) | |
| Operator | target location, and work to perform, etc. |
| Commands | |
| (human) | |
| Experience | Simulation results, AI neural network weights (i.e., |
| Data | policy and/or value networks), experience buffer |
| | (environment states, actions, following states, |
| | following actions, rewards, transition probabilities), |
| | order data, vehicle state, vehicle commands, |
| | operator state, and operator commands. |

The order data originates from an order management system 206, which is generated based on the order fulfilment requirements of the customer (e.g., a customer orders a plurality of items online which are stored in the warehouse 100). The order data is communicated to the AI controller 202, and the AI controller 202 uses this information, together with other information available to it, to generate commands. The AI controller 202 transmits them to the vehicle management and execution system 204, which subsequently uses this information to control and direct the movements of exemplary vehicles (e.g., Robotic pickers and robotic vehicles) 104, 106. The vehicle state data is communicated by the vehicles 104, 106 of the vehicle fleet to the vehicle management & execution system 204, which passes the vehicle state data to the AI controller 202.

Once the vehicles 104, 106 have performed their tasks for the relevant orders, the order completion and status information are also transmitted by the vehicle management and execution system 204 to the AI controller 202, as well as to the order management system 206 in order to communicate the completion and other operational information about the status of the order.

Lastly, for human workers operating within the system and carrying out order tasks (such as picking items from shelves), the operator HMIs 208 (human-machine interfaces, e.g., a user interactive screen) send and receive order data from the order management system 206 and sends order completion and status data to the AI controller 202. The operator state data is communicated by the respective operator HMIs 208 to the AI controller 202. The operator commands are communicated by the AI controller 202 to the operator HMIs 208 (for execution by the operators of the respective operator HMIs 208).

The experience data (which includes simulation results, AI neural network weights, buffer data (states actions, state data, etc.), order data, vehicle data, vehicle commands, operator state(s), and operator commands) are communicated back and forth between a training cluster 210 and an experience storage 212, between the training cluster 210 and the AI controller 202, and between the experience storage 212 and the AI controller 202. This ensures that the AI controller 202 can use this experience in the future while re-training, and to augment the digital twin simulation (in the training cluster 210) with real operational data. Note that each server or database component can be implemented as cloud-based or on-location. Note that the dashed lines in FIG. 2 indicate a wireless transfer of data (e.g., via Wi-Fi, 5G, etc.).

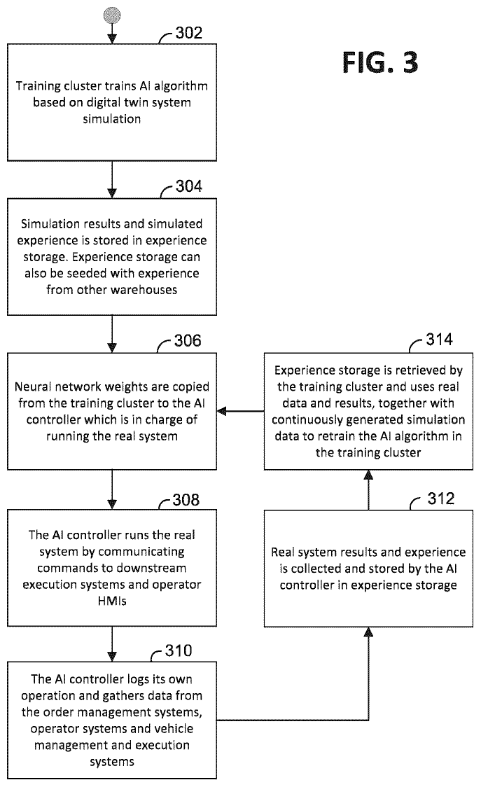

FIG. 3 illustrates the steps to an operational flow for an exemplary process for training and updating algorithms provided by the AI controller for execution by the vehicles of the vehicle fleet and/or the operators with their operator HMIs.

In step 302, the training cluster trains an AI algorithm based on a digital twin system simulation. In step 304, simulation results and simulated experience are stored in the experience storage.

In one embodiment, the experience storage is configured to be seeded with experience from other warehouses. In step 306, updated neural network weights are copied from the training cluster to the AI controller, which is in charge of running the real (“live”) system. These updated neural network weights are used to update an algorithm, changing its execution characteristics, and leading to an improvement in performance.

In step 308, the AI controller, using the updated algorithm, runs the real, or live, system by communicating commands to downstream execution systems and operator HMIs. In step 310, the AI controller logs its own operation and gathers data from the order management systems, operator systems, and the vehicle management & execution systems. In step 312, the real system results and the experience data are collected and stored by the AI controller in the experience storage. In step 314, the experience storage is retrieved by the training cluster and uses the real data and results, together with continually generated simulation data to retrain the AI algorithm in the training cluster. The operational flow then continues back to step 306, where the updated neural network weights are copied from the training cluster again to the AI controller (to update the algorithm).

FIGS. 4A, 4B and 4C illustrate three exemplary neural network architectures, which represent the “Agent(s)” part of the diagram in FIG. 4. The neural networks are used to command two exemplary classes of workers, hereafter referred to as AGVs and pickers:
FIG. 4A—central reinforcement learning controller.
FIG. 4B—multi-agent reinforcement learning controller.
FIG. 4C—hierarchical multi-agent reinforcement learning controller.

FIGS. 4A, 4B and 4C present reinforcement learning controllers based on the advantage actor critic algorithm (A2C) with internal neural networks which can be trained, where inputs are applied to a first set of nodes (input layer), and outputs of the first set of nodes applied to a second set of nodes (hidden layer), then into a final set of nodes (output layer). While the A2C algorithm was chosen in this example, other reinforcement learning algorithm architectures can be used, such as, Proximal Policy Optimization (PPO), Soft Actor Critic (SAC), Deep Deterministic Policy Gradient (DDPG), Deep Q Networks (DQN) or other value optimization algorithms. In addition, in FIG. 4B, multi-agent reinforcement learning architectures can be used, whether value or policy based, such as, Independent Q-Learning (IQL), Multi-agent Deep Deterministic Policy Gradient (MADDPG), Counterfactual Multi-agent Policy Gradient (COMA), Value Decomposition Networks (VDN), or Monotonic Value Function Factorization (QMIX), etc. In this A2C example, the neural network weights are learned within these networks via standard A2C reinforcement learning loss functions. The final output layer in the policy network with a plurality of nodes (e.g., four (4) nodes) provides the action probabilities that will be statistically sampled and executed, representing an improved algorithm for execution by the AI controller. The value network will typically output a single value which is an estimation of favourability of the current state of the system and is used in the loss calculations to assist in learning.

### Central Reinforcement Learning Controller:

In FIG. 4A, the inputs to the reinforcement learning controller include current worker locations (both AGVs & pickers), target worker locations (AGVs & pickers), and remaining pick locations (for the AGVs). Additional inputs may include work arrival times (AGVs & pickers), worker distance to target (AGVs & pickers), and number of orders completed. As illustrated in FIG. 4A, the output of the statistical sampling method described above may include an exemplary worker destination location, which is given to the worker to carry out.

### Multi-Agent Reinforcement Learning Controller:

In FIG. 4B, the inputs to the multi-agent reinforcement learning controller(s) include the same information as per the exemplary configuration illustrated in FIG. 4A. Subsets of this information can be provided to each separate controller as needed to reduce network input complexity. A plurality of controllers can exist, with pros and cons for different configuration. One exemplary configuration is to have a controller per worker (e.g., 3 pickers, 3 AGVs, 6 controllers-1 controller per worker), which has the advantage of more individual behaviour for the workers allowing them to specialize further but reduces the ability of the workers to share experience and thus makes training more complex. Another exemplary configuration is to have a controller per worker class (e.g., 3 pickers, 3 AGVs, 2 controllers-1 Picker controller, 1 AGV controller), which has the advantage of making training more efficient as they can share experience but reduces the ability for the workers to exhibit individual behaviour which may be beneficial in some circumstances. As illustrated in FIG. 4B, the output of the statistical sampling method described above may include an exemplary worker destination location, which is given to the worker to carry out.

### Hierarchical Multi-Agent Reinforcement Learning Controller:

In FIG. 4C, the inputs to the multi-agent reinforcement learning controller(s) include the same information as per the exemplary configurations illustrated in FIGS. 4A and 4B. Subsets of this information can be provided to each separate controller as needed to reduce network input complexity. The key difference in this configuration is the introduction of a manager agent, which communicates goals to other reinforcement learning controllers. An exemplary goal from a manager agent to a worker contains the target warehouse section the manager wants all individual workers to go to. As in the exemplary configuration illustrated in FIG. 4B, a plurality of controllers can exist, with the same pros and cons for different configurations. One exemplary configuration is to have a controller per worker (e.g., 3 pickers, 3 AGVs, 1 manager; resulting in 7 controllers-1 controller per worker and 1 controller for the manager) with its associated advantages and disadvantages as outlined in the configuration illustrated in FIG. 4B. Another exemplary configuration is to have a controller per worker class (e.g., 3 pickers, 3 AGVs, 1 manager; resulting in 3 controllers-1 picker controller, 1 AGV controller, 1 manager controller) with its associated advantages and disadvantages as outlined in the configuration illustrated in FIG. 4B. As illustrated in FIG. 4B, the output of the statistical sampling method described above may include an exemplary worker destination location, which is given to the worker to carry out, and the worker target section as generated by the manager agent.

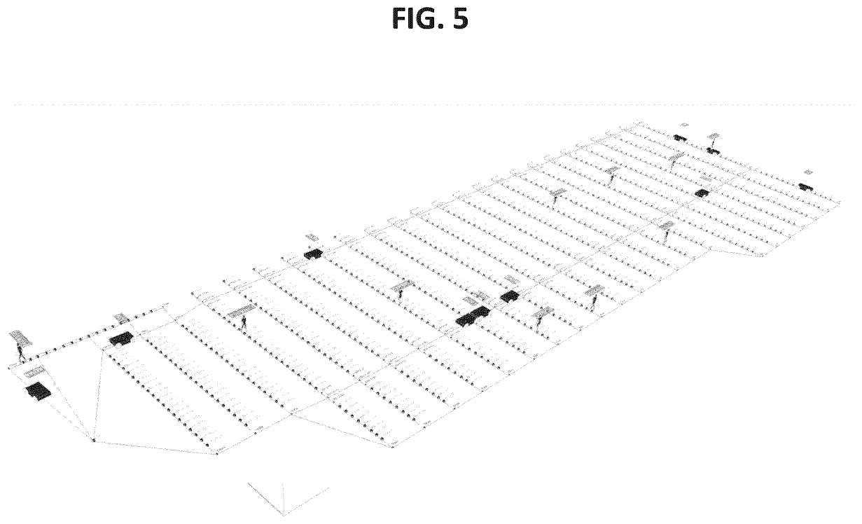

As illustrated in FIG. 5, exemplary machine learning solutions include a warehouse simulator. The exemplary warehouse simulation illustrated in FIG. 5 is a high-performance 3D simulator run on a processor that can represent arbitrary warehouses, manage order generation and allocation, as well as AGV control systems to navigate workers through the simulated warehouse. Any controlled entity is denoted a “worker” in accordance with usage throughout this invention.

The warehouse simulations include AGVs configured to collect and deliver ordered items, as well as pickers responsible for collecting and placing items onto the AGVs. The complexity of the task performance by the warehouse control system is largely given by the number of AGVs, number of pickers, and the number of item locations in the warehouse.

As discussed herein, the example warehouse includes two types of workers configured to perform distinct tasks and each with particular capabilities. AGVs represent robotic automated guided vehicles (AGVs) which are sequentially assigned orders. For each order, an AGV collects specific items in given quantities. Once all ordered items are collected, the AGV moves to a specific location to deliver and complete the order. Upon completion, the AGV is assigned a new order (as long as there are still outstanding, unassigned orders remaining).

The exemplary pickers are configured to move across the same locations as the AGVs and are needed to pick and load any needed items onto the AGVs. For a picker to load an item onto an AGV, both workers have to be located at the location of that particular item. As also discussed herein, the picker may be either a robotic picker or a human picker.

The warehouse simulator is also compatible with real customer data to create simulations of real-world warehouse systems.

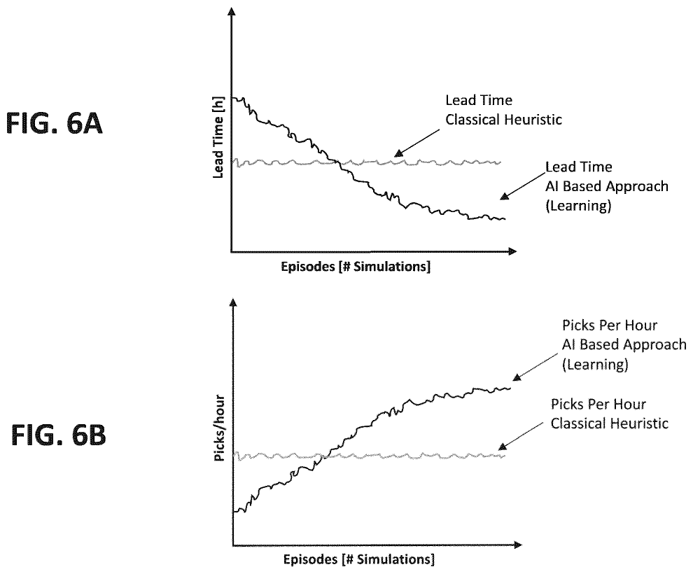

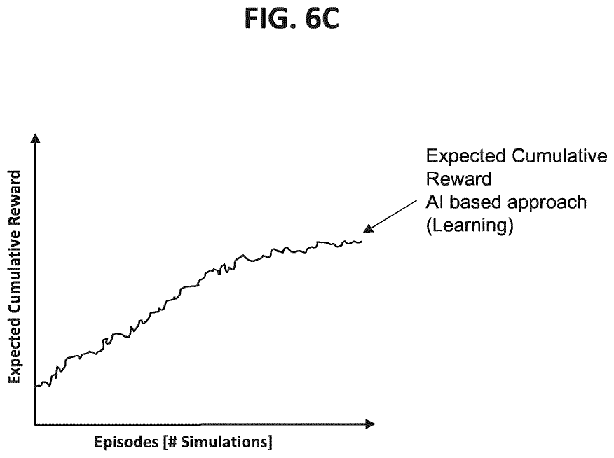

FIGS. 6A and 6B illustrate the results of an exemplary case study utilising the high-performance simulator in FIG. 5 and the exemplary neural network architecture illustrated in FIG. 4C, with 1 manager agent, 1 AGV Agent (controlling thirty (30) AGV workers) and 1 picker agent (controlling fifteen (15) human picker agents) in a warehouse with over 700 distinct locations. Three key performance indicators are defined, which include the order picking lead time, the picks per hour, and the expected cumulative reward. As compared to a classical heuristic (baseline) algorithm, coded by an expert programmer to carry out the order fulfilment task, the AI based approach resulted in an exemplary 22% lead time improvement. FIG. 6C illustrates the improvement in the expected cumulative reward the algorithm can obtain during the learning process which is correlated to the KPI improvement shown in FIGS. 6A and 6B.

Thus, embodiments of the exemplary neural networks are configured to provide a highly flexible solution that dynamically responds to changing warehouse operations and order conditions. Such flexible solutions can be applied to every warehouse with highly variable customer conditions. Exemplary algorithmic solutions are discovered that are well suited to customer conditions and continually account for changes in operational conditions.

Changes and modifications in the specifically described embodiments can be carried out without departing from the principles of the present invention which is intended to be limited only by the scope of the appended claims, as interpreted according to the principles of patent law including the doctrine of equivalents.

1. An order fulfillment control system for a warehouse, the order fulfillment control system comprising:
a warehouse simulation configured to continually perform warehouse simulations comprising simulated runs of order fulfillment activities;
a storage module configured to retain and store operational data comprising results data and experience data, and wherein the warehouse simulation is configured to output simulated operational data to the storage module;
a controller configured to control the order fulfillment activities of a plurality of agents, and wherein the controller is configured to record live operational data while the agents are performing their order fulfillment activities, and wherein the controller is configured to output the live operational data to the storage module;
a training module configured to retrieve the live operational data and the simulated operational data stored in the storage module, wherein the training module is configured to train an algorithm using the live operational data and the simulated operational data, and wherein the training module is configured to generate neural network weight results for the algorithm and to forward them to the controller; and
wherein the controller is configured to update the algorithm with the received neural network weight results and to control the order fulfillment activities of the plurality of agents using the updated algorithm.

2. The order picking control system of claim 1, wherein the training module comprises a neural network configured to iteratively perform training runs, wherein the training runs replay the simulated operational data and the live operational data in an attempt to find optimal neural network weight results for an optimal algorithm, wherein the optimal algorithm is defined by the desired priorities for the order fulfillment activities in the warehouse.

3. The order fulfillment control system of claim 1, wherein the agents comprise pluralities of human pickers, robot pickers, and automated guided vehicles (AGVs).

4. The order fulfillment control system of claim 3, wherein the controller is configured to control the AGVs and robot pickers via executable commands communicated by the controller.

5. The order fulfillment control system of claim 3, wherein the AGVs comprise transport vehicles configured to collect and deliver ordered items within the warehouse.

6. The order fulfillment control system of claim 5, wherein the robot pickers are configured to collect and place the ordered items onto the transport vehicles.

7. The order fulfillment control system of claim 5, wherein the controller is configured to control the human pickers via executable commands communicated by the controller to human-machine interfaces (HMIs), and wherein each HMI is configured to guide a respective human picker in order fulfillment activities.

8. The order fulfillment control system of claim 7, wherein the guided fulfillment activities comprise collecting and placing the ordered items onto the transport vehicles.

9. The order fulfillment control system of claim 2, wherein the warehouse simulation is a digital twin simulation of the warehouse, and wherein the warehouse simulation is configured to perform one of a single instance of a warehouse simulation or a plurality of warehouse simulation instances.

10. A method for controlling order fulfillment activities of a plurality of agents in a warehouse, the method comprising:
continually performing warehouse simulations comprising simulated runs of order fulfillment activities;
retaining and storing, in a storage module, operational data comprising results data and experience data;
outputting simulated operational data from the simulated runs of order fulfillment activities to the storage module;
controlling order fulfillment activities of the plurality of agents;
recording live operational data while the agents are performing their order fulfillment activities;
outputting the live operational data to the storage module;
retrieving the live operational data and the simulated operational data stored in the storage module;
training an algorithm using the retrieved live operational data and simulated operational data;
generating neural network weight results for the algorithm; and
updating the algorithm with the received neural network weight results and controlling the order fulfillment activities of the plurality of agents using the updated algorithm.

11. The method of claim 10, wherein the training of an algorithm comprises of iteratively performing training runs which replay the simulated operational data and the live operational data in an attempt to find optimal neural network weight results for an optimal algorithm, and wherein the optimal algorithm is defined by the desired priorities for the order fulfillment activities in the warehouse.

12. The method of claim 10, wherein the agents comprise pluralities of human pickers, robot pickers, and automated guided vehicles (AGVs).

13. The method of claim 12, wherein the controlling order fulfillment activities of the plurality of agents comprises communicating executable commands to the AGVs and robot pickers.

14. The method of claim 12, wherein the AGVs comprise transport vehicles configured to collect and deliver ordered items within the warehouse.

15. The method of claim 14, wherein the robot pickers are configured to collect and place the ordered items onto the transport vehicles.

16. The method of claim 14 further comprising controlling human pickers via executable commands communicated to human-machine interfaces (HMIs), and wherein each HMI guides a respective human picker in order fulfillment activities.

17. The method of claim 16, wherein the guided fulfillment activities comprise collecting and placing the ordered items onto the transport vehicles.

18. The method of claim 10, wherein continually performing warehouse simulations comprises performing one of a single instance of a warehouse simulation or a plurality of warehouse simulation instances.

19. The method of claim 11, wherein the agents comprise pluralities of human pickers, robot pickers, and automated guided vehicles (AGVs).

20. The order fulfillment control system of claim 1, wherein the warehouse simulation is a digital twin simulation of the warehouse, and wherein the warehouse simulation is configured to perform one of a single instance of a warehouse simulation or a plurality of warehouse simulation instances.
